(19) United States
(12) Patent Application Publication
(10) Pub. No.: US 2019/0205901 A1
(43) Pub. Date: Jul. 4, 2019

(54) DYNAMIC CREATION OF CONTENT ITEMS FOR DISTRIBUTION IN AN ONLINE SYSTEM BY COMBINING CONTENT COMPONENTS

(71) Applicant: Facebook, Inc., Menlo Park, CA (US)

(72) Inventor: Zhurun Zhang, Bellevue, WA (US)

(21) Appl. No.: 15/858,850

(22) Filed: Dec. 29, 2017

(51) Int. Cl. G06Q 30/02; G06N 99/00; H04L 29/08

(52) U.S. Cl. CPC G06Q 30/0201; H04L 67/10; G06N 99/005

(57) ABSTRACT

An online system generates dynamically optimized content for a target user of the online system. To do so, the online system receives content component from a content provider system and generates a pool of content items assembled from the content components for a target audience. The online system presents the content items in the pool to users of the online system and tracks the performance of each content item. The online system modifies the pool of content items to eliminate content components that are poorly performing while propagating content components that are highly performing. Therefore, over multiple iterations, the final pool of content items is increasingly tailored for a target audience. Upon receiving a request to present a content item for a user that meets the characteristic of the target audience, the online system selects a content item from the final pool to be presented to the user.

### BACKGROUND

This disclosure generally relates to online content distribution, and more specifically to dynamically creating content items by combining individual content components for distribution to a target audience in an online system.

Content providers produce content that is targeted to certain audiences within online systems. Users interact with content received from the online system. With the advent of online systems such as social networking systems, content providers have increasingly relied on the online systems to create distribute content to users of the online system to greatly increase engagement with users of the online systems. For example, subsequent to presenting sponsored content provided by a content provider to users of an online system, the online system tracks how often the users interact with the presented content and calculates statistics for the content. These statistics may be accrued over numerous time intervals and serve to measure the effectiveness of each content item. Based on these statistics, the content provider can edit content items that perform poorly or alternatively choose to show content items that have performed very effectively.

Currently, content providers face challenges in ensuring that the best possible content item is created and delivered to each user of the online system. For example, current solutions only enable a content provider to present pre-assembled content items to users of an online system. Online systems can track the performance of pre-assembled content items but provide zero or very little feedback to content providers about the performance of particular components (e.g., text, images and videos) of a content item. In other words, content providers cannot “see inside a content item” to understand which components of the content item did not perform well for their objectives or target audience. Therefore, in many scenarios, content provided to users of an online system remains sub-optimally tailored.

### SUMMARY

An online system, such as a social networking system, presents content items to users of the online system. A content item is assembled from a number of different types of content components. Examples of different types of content components include images, videos, bodies of text, “call to action types” (e.g. install application, play application), titles, descriptions, universal resource locators (URL), and captions.

The online system receives components of content items from a content provider system and combines them to generate multiple pools of content items. Each pool of content items is specific for a target audience that is defined by a common characteristic such as age, gender, demographic group, interests, and the like. The online system presents the content items in the pool to users of the online system that meet the characteristic of the target audience for a trial period. During this trial period, the online system tracks the performance of each of the content items presented to the users. The online system modifies the pool of content items by removing content items that perform poorly while generating and including additional content items. Specifically, the additional content items are assembled from content components that are also included in content items that remain in the pool. Altogether, the online system modifies the pool of content items to eliminate content components that are poorly performing while propagating content components that are highly performing. The online system can iteratively modify the pool of content items by continuing to remove and add content items for additional trial periods.

The online system receives a request to present a content item to a target user of the online system. Therefore, the online system can select a content item best suited for the target user from the final pool of content items. Generally, each target user of the online system can be presented with a tailored content item. Therefore, different users of the online system are provided with unique content items from the final pool of content items, each composed of different content components.

### BRIEF DESCRIPTION OF THE DRAWINGS

FIG. 1 is a system environment of an online system for generating dynamically optimized content items for target users of the online system, in accordance with one embodiment.

FIG. 2A is a block diagram of a dynamic content item generation module, in accordance with one embodiment.

FIG. 2B is a block diagram of a genetic modification module, in accordance with one embodiment.

FIG. 3 is an illustration of a content item that includes multiple content components, in accordance with one embodiment.

FIG. 4 is an illustration of the iterative process of genetically modifying content items, in accordance with one embodiment.

FIG. 5 is a flow diagram for providing an optimized content item to a user of the online system, in accordance with one embodiment.

FIG. 6 is a detailed flow process for iteratively modifying the pool of content items, in accordance with an embodiment.

The figures depict various embodiments for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of System Environment

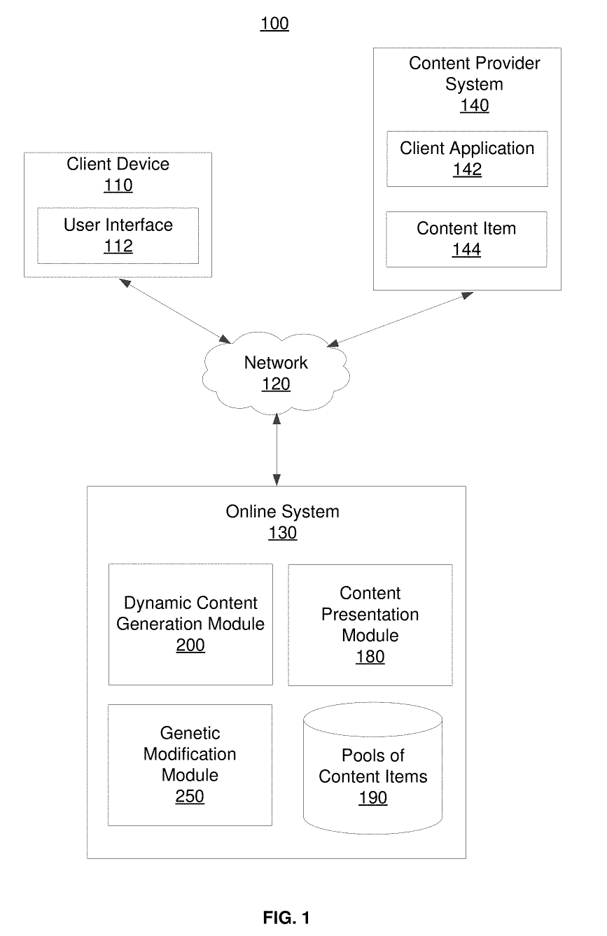

FIG. 1 is a system environment 100 of an online system 130 for generating dynamically optimized content items for target users of the online system 130, in accordance with one embodiment. As shown in FIG. 1, the system environment 100 includes one or more client devices 110, a content provider system 140, and an online system 130 connected through a network 120. While FIG. 1 shows one client device 110 for simplicity, the client device 110 including a user interface 112 that a user can provide input to, and one content provider system 140, it should be appreciated that any number of these entities (including millions) may be included. In alternative configurations, different and/or additional entities may also be included in the system environment 100.

A client device 110 is a computing device capable of receiving user input through a user interface 112, as well as transmitting and/or receiving data via the network 120. Examples of client devices 110 include desktop computers, laptop computers, tablet computers (pads), mobile phones, personal digital assistants (PDAs), gaming devices, or any other electronic device including computing functionality and data communication capabilities. A user of the client device 110 accesses the online system 130 and interacts with content provided by the online system 130 or by the content provider system 140. For example, the user may retrieve the content for viewing and indicate an affinity towards the content by posting comments about the content or recommending the content to other users. Alternatively a user may indicate a dislike towards the content by flagging the content or closing or hiding the content window, thereby indicating that the user is not interested in the content.

The network 120 facilitates communications among one or more client devices 110, the online system 130, and/or one or more content provider systems 140. The network 120 may be any wired or wireless local area network (LAN) and/or wide area network (WAN), such as an intranet, an extranet, or the Internet. In various embodiments, the network 120 uses standard communication technologies and/or protocols. Examples of technologies used by the network 120 include Ethernet, 802.11, 3G, 4G, 802.16, or any other suitable communication technology. The network 120 may use wireless, wired, or a combination of wireless and wired communication technologies. Examples of protocols used by the network 120 include transmission control protocol/Internet protocol (TCP/IP), hypertext transport protocol (HTTP), simple mail transfer protocol (SMTP), file transfer protocol (TCP), or any other suitable communication protocol.

The content provider system 140 is used by content providers for interacting with the online system 130. Examples of interactions include providing content, providing components (also referred to as “assets”) of the content, and providing information related to the content and the components. In the embodiment shown in FIG. 1, the content provider system 140 has a client application 142 and a content item 144. The content provider system 140 interacts with the online system 130 using application programming interfaces (APIs) of the online system 130. The client application 142 allows users associated with content provider system 140 to interact with the online system 130. The client application 142 may present a user interface that is different from the user interface of the client device 110.

The content provider system 140 provides one or more content items 144 and/or components to be included in a content item 144 to the online system 130. A content item 144 may be sponsored content such as advertisements sponsored by advertisers. In various embodiments, a content item 144 is a combination of a number of content components (also called “assets”); each content component is a part of the content item 144 to be presented to a target user and each content component is of a component type. Examples of component types include image, video, body representing the primary message of the content item, call to action type (e.g., shop_now, learn_more, etc.,), title representing a short headline in the content item, description representing secondary message of the content item, URL, and caption representing corresponding text of an URL. In one embodiment, a content provider system 140 provides a content item 144 having a set of predetermined content components to the online system 130 for presentation to a target user, e.g., {image A, title A, body B}. In another embodiment, a content provider system 140 provides a set of content components to the online system 130, and the online system 130 dynamically determines which content components to use in the content item 144 to be delivered to a user of a target audience or to a target user. For example, a content provider system 140 is able to provide a content item 144 in a set having the following different types of content components:

```
{
    Images: {ImageA, ImageB, ImageC}
    Titles: {TitleA, TitleB, TitleC}
    Body: {BodyA, BodyB, BodyC}
}
```

Referring now to the online system 130 in FIG. 1, the online system 130 communicates via the network 120 with the content provider system 140, and/or with one or more client devices 110. Generally, the online system 130 receives content from a content provider system 140 and provides a content item tailored for a user of the online system 130 to one or more client devices 110. In one embodiment, the online system 130 receives a content item 144 having a set of predetermined content components. In another embodiment, the online system 130 receives a set of content components and dynamically assembles various content items for a user of a target audience or for a target user. The online system 130 determines the best performing content components from the various content items, assembles a content item that includes the best performing content components, and then delivers the content item to the target audience. For simplicity, the content item 144 having a set of predetermined content components is referred to as “pre-assembled content item” and the content item to be dynamically assembled by the online system 130 may be referred to as “dynamically assembled content item.” In the embodiment shown in FIG. 1, the online system 130 includes a dynamic content generation module 200, a genetic modification module 250, and a content presentation module 180.

Generally, the dynamic content generation module 200 generates an initial pool of content items for a target audience by assembling the content components received from the content provider system 140, each content component having a content component type such as a title, image, video, body, and the like. A pool of content items is generated for a target audience. The target audience typically shares one or more defining characteristics such as age, gender, demographic group, socioeconomic status, and the like.

In one embodiment, the dynamic content generation module 200 randomly selects content components that are to be included in a content item. In another embodiment, the dynamic content generation module 200 analyzes the content components and selects the content components that are likely to be of most interest to the target audience. Therefore, the dynamic content generation module 200 can generate an initial pool of content items that include content components that are likely to be of highest interest to the target audience.

The genetic modification module 250 modifies the existing pool of content items by generating additional content items as well as removing existing content items from the pool. These additional content items are assembled from content components that were included in highly performing content items in the existing pool of content items. The identification of highly performing content items is described in further detail below. Briefly, one example process of identifying highly performing content items includes presenting the content items to a target audience and monitoring interactions between individuals of the target audience and the presented content item. Altogether, the genetic modification module 250 generates additional content items which can then serve as the content item that is selected and presented to a target user of the online system 130.

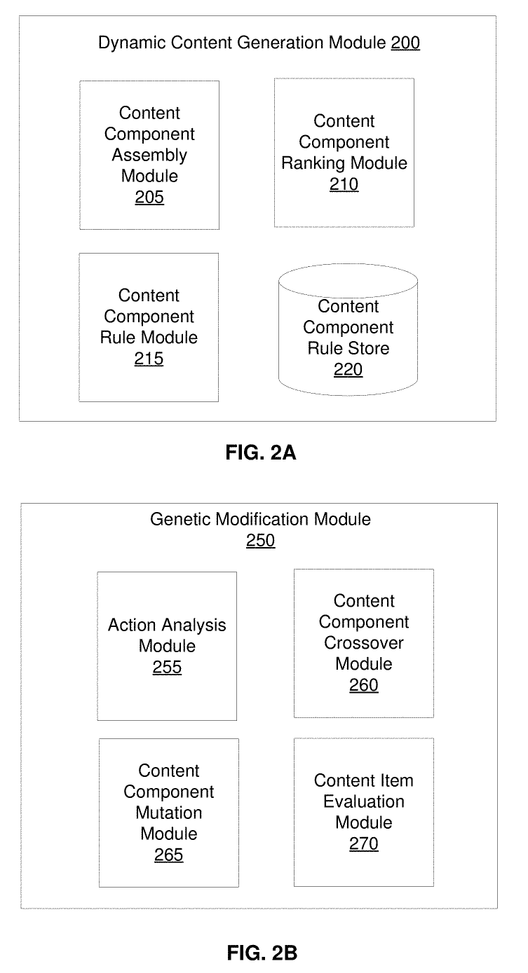

In various embodiments, the genetic modification module 250 performs an iterative process of modifying the existing pool of content items. For example, at a first iteration, the genetic modification module 250 identifies highly performing content items in the existing pool, where the content items were previously generated by the dynamic content generation module 200. The genetic modification module 250 generates additional content items assembled from content components included in the highly performing content items and adds the additional content items to the pool of content items. At a second iteration, the genetic modification module 250 identifies highly performing content items from the pool, which further includes the additional content items. The genetic modification module 250 can further generate additional content items to add to the pool of content items, and can further iterate the process. The methods performed by the genetic modification module 250 is described in further detail in regards to FIG. 2B.

The content presentation module 180 presents assembled content items to client devices 110 through the network. In one embodiment, the content presentation module 180 provides content items to client devices 110 for the purpose of determining highly performing content items which can then be used by the genetic modification module 250 as described above. For example, the content presentation module 180 retrieves content items from a pool of content items that was previously generated (e.g., by the dynamic content generation module 200). The content presentation module 180 provides the retrieved content items from the pool to multiple client devices 110. In particular, the content presentation module 180 provides the content items to client devices 110 that are associated with users of the online system 130, where the user attributes match the defining characteristics of the target audience that the pool of content items was generated for. In some embodiments, the content presentation module 180 provides the content items retrieved from the pool of content items to client devices 110 for a pre-determined amount of time (e.g., several hours, a day, a week) such that users of the client devices 110 are able to interact with the presented content items. By doing so, the content items can be evaluated during this pre-determined amount of time, which can serve as a trial period for each content item.

In another embodiment, the content presentation module 180 provides content items to client devices 110 that are specifically tailored for a user of the online system 130. In various embodiments, the content presentation module 180 provides different content items to different client devices 110. Using the sample example described above, the online system 130 dynamically decides which content components to be included in a content item to delivered to a target user, e.g., for user 1, the content item includes {TitleB, ImageB and BodyB}; for a different user, e.g., for user 2, the content item includes {TitleC, ImageA, BodyC}.

Turning back to FIG. 1, the online system 130 may be a social networking system that additionally permits users to establish connections (e.g., friendship type relationships, follower type relationships, etc.) between one another. In one embodiment, the online system 130 stores user accounts and/or user profiles describing the users of the online system 130. User profiles are associated with the user accounts and include information describing the users, such as demographic data (e.g., gender information), biographic data (e.g., interest information), etc. Using information in the user profiles, connections between users, and any other suitable information, the online system 130 maintains a social graph of nodes interconnected by edges. Each node in the social graph represents an object associated with the online system 130 that may act on and/or be acted upon by another object associated with the online system 130. An edge between two nodes in the social graph represents a particular kind of connection between the two nodes. An edge may indicate that a particular user of the online system 130 has shown interest in a particular subject matter associated with a sponsored content. For example, the user profile may be associated with edges that define a user's prior activity that includes, but is not limited to, visits to various web pages, searches for web pages, commenting and sharing web pages, liking content items, commenting on content items, sharing content items, joining groups, attending events, checking-in to locations, and buying products advertised by advertisements presented to the user.

In one embodiment, the online system 130 may use edges to generate stories describing actions performed by users, which are communicated to one or more additional users connected to the users through the online system 130. For example, the online system 130 may present a story to an additional user about a first user (e.g. a friend) that has liked a new game or application advertised by a sponsored content item presented to the first user. The additional user may choose to interact with the presented story thereby creating an edge in the social graph maintained by the online system 130 between the additional user and the subject matter of the story. The online system 130 may store this edge. This edge may be retrieved at a future time point when the online system 130 seeks to identify components that may align well with the additional user's preferences.

In some embodiments, a content item is a sponsored content item, i.e., an advertisement for which the online system receives remuneration for distributing the content item to users of the online system. In these embodiments, the content provider is an advertiser. In various embodiments, in addition to receiving content components and/or content items 144 from the content provider system 140, the online system 130 may also receive one or more advertisement requests. In various embodiments, an advertisement request includes a landing page specifying a uniform resource locator (URL) to which a user is directed when the advertisement is accessed. An advertisement request can include targeting criteria that specifies characteristics of a target user such as a user's age, sex, demographic information, interests, and the like. An advertisement request from an advertiser also includes a bid amount associated with an advertisement. The bid amount is used to determine an expected value, such as monetary compensation, provided by an advertiser to the online system 130 if the advertisement is presented to a user, if the advertisement receives a user interaction, or based on any other suitable condition. For example, the bid amount specifies a monetary amount that the online system 130 receives from the advertiser if the advertisement is displayed and the expected value is determined by multiplying the bid amount by a probability of the advertisement being accessed.

### Generating a Pool of Content Items

FIG. 2A is a block diagram of the dynamic content generation module 200 shown in FIG. 1 in accordance with an embodiment of the invention. The dynamic content generation module 200 receives a set of content components from a content provider system 140 and creates a content item that is included in the initial pool of content items.

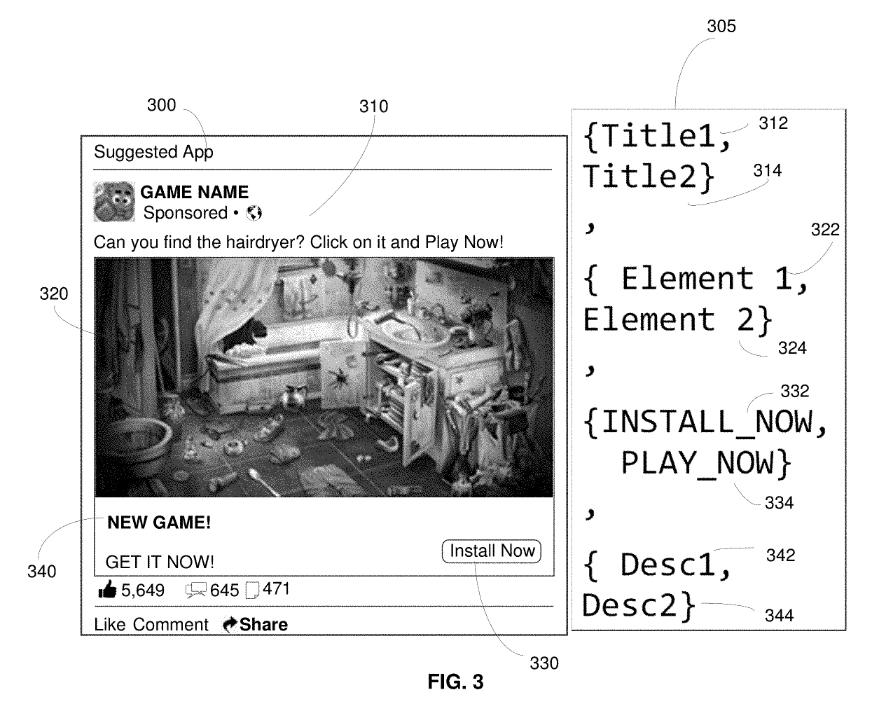

Turning briefly to FIG. 3, FIG. 3 is an illustration of an example content item 300 that includes content components selected and assembled by the content component assembly module 205, in accordance with an embodiment. In the specific embodiment shown in FIG. 3, a content provider system 140 provides, to the online system 130, a set of content components 305, including two titles: Title1 312 and Title2 314, two image elements, Element 1 322 and Element 2 324, two call to action types: INSTALL_NOW 332 and PLAY_NOW 334, and two descriptions: Desc1 342 and Desc2 344. The content component assembly module 205 selects content components for each type to be included in the content item 300. For example, the online system 130 selects a title 310 (i.e., “Can you find the hairdryer? Click on it and Play Now!”) from two title candidates 312 and 314, an image 320 from two image candidates 322 and 324, a call_for_action type 330 (i.e., “Install Now”) from the two call_for_action type candidates 332 and 334, and a description 340 (i.e., “NEW GAME”) from two description candidates 342 and 344. This content item 300 can be included in a pool of content items for a target audience.

In various embodiments, each pool of content items is specific for a target audience with one or more defining characteristics. For example, a first pool of content items may be generated for individuals in a target audience that are within a certain age range (e.g., 18-25 year old). A second pool of content items may be generated for individuals that are of a certain ethnic group. Generally, characteristics of a target audience include age, gender, demographic group, interests (both explicit interests and inferred interests), and the like. The dynamic content generation module 200 includes a content component assembly module 205, a content component ranking module 210, and a content component rule module 215. In alternative configurations, less, different and/or additional modules may also be included in the dynamic content generation module 200.

### Selecting Content Components to be Included in a Content Item

The content component assembly module 205 selects content components and generates a content item that includes the selected content components. In some embodiments, in generating the content item, the content component assembly module 205 randomly selects the content components from the content components that provided by the content provider system 140. For example, the dynamic content generation module 200 can randomly select a title content component, an image content component, a body content component, and so forth to be included in the content item. In some embodiments, the specific number of each type of content component to be included in a content item can be specified by the content provider system 140 or it can be determined by the online system 130. In another embodiment, the dynamic content generation module 200 randomly selects the number of each type of content component that is within a range (e.g., 1 to 3 content components of a certain type) provided by the content provider system 140 or determined by the online system 130. In some embodiments, the placement of each selected content component is pre-determined (e.g., by a template) and as such, the content component assembly module 205 can place each selected content component into a pre-determined location to generate the content item. In another embodiment, the dynamic content generation module 200 organizes the selected content components into a content item without a pre-determined template.

In other embodiments, the content component assembly module 205 analyzes the received content components to determine the content components to be included in a content item. As an example, the content component assembly module 205 can apply a machine learning model to each content component with a particular content component type, the machine learning model trained to predict a likelihood that a user of the target audience would be interested in a content item that includes the content component. The application of a content component as input to a machine learning model to predict interest in the content component is described in further detail in U.S. application Ser. No. 15/199,386, which is hereby incorporated by reference in its entirety.

As an example, the content component assembly module 205 trains and applies a machine learning based model that is specific for a content component type e.g., an image model is applied for image content components. A machine learning model can be trained using one or more machine learning algorithms such as neural networks, naive Bayes, and support vector machines. The trained machine learning based model receives, as inputs, the content component and one or more defining characteristics of the target audience (e.g., the target audience corresponding to the pool of content items). In various embodiments, the content component assembly module 205 performs a feature extraction process to extract features (e.g., text strings, image features such as color, width/height, object edges, and the like) from the content component, and assembles a feature vector that is provided as input to the trained machine learning based model. In some embodiments, the feature vector further includes the defining characteristics of the target audience.

An example feature vector for an image content component with extracted features (e.g., width and height) and a target audience defined by characteristics (e.g., age and gender) is as follows:

{
Feature1: age
Feature2: gender
Feature 3: image width
Feature 4: image height
}

Although this example feature vector depicts 4 different features (2 from an individual in the target audience, 2 from the image content component), one skilled in the art can appreciate that in other examples, there may be thousands of additional features associated with the user and the image content component that may be included.

The trained machine learning based model generates a prediction score for that content component. In various embodiments, a prediction score for a content component represents the likelihood that an individual of the target audience interacts with a content item that includes the content component.

As an example, assume that the content provider system 140 provides to the online system 130 two images, ImageA and ImageB, and three titles, TitleA, TitleB, and TitleC, to be considered for a content item for a target user, User. The content component assembly module 205 applies an image model, e.g., ImageModel, to each of the two images and generates a prediction score for each image. Similarly, the content component assembly module 205 applies a title model, e.g., TitleModel, to each of the three titles and generates a prediction score for each title. An example pseudocode for the operations of the content component assembly module 205 is as follows:

{
ImageModel (ImageA, Audience) = 0.50;
ImageModel (ImageB, Audience) = 0.55; //ImageB will be selected for Audience.
TitleModel (TitleA, Audience) = 0.30;
TitleModel (TitleB, Audience) = 0.35;
TitleModel (TitleC, Audience) = 0.40; //TitleC will be selected for Audience.
}

The content component ranking module 210 ranks each content component according to the prediction score associated with the content component. For example, using the prediction scores, the content component ranking module 210 ranks the content component candidates for each content component type and selects a content component having the highest prediction score among all content components of the same type. Using the example above, the image content components would be ranked as follows: 1) ImageB (score=0.55), 2) ImageA (score=0.50). Additionally, the title content components would be ranked as follows: 1) TitleC (score=0.40), 2) TitleB (score=0.35), and 3) TitleA (score=0.30).

Based on the prediction scores, the content component ranking module 210 selects an image content component having the highest prediction score (e.g., ImageB) from the two image content components and a title having the highest prediction score (e.g., TitleC) among the three title content components. In various embodiments, instead of selecting the top content component for each content component type, the content component ranking module 210 selects the N top content components for each content component type to be used to generate multiple content items to be included in the pool of content items.

Returning to the content component assembly module 205, the content component assembly module 205 receives an indication of the selected content components of the content item from the content component ranking module 210 and fully assembles the selected content components into one or more content items to be included in the initial pool of content items. As one example, if the content component assembly module 205 receives an indication that the top 3 image content components and top 3 title content components were selected, the content component assembly module 205 can generate 9 different content items (e.g., 3×3 combinations) using the selected content components that are then included in the initial pool of content items.

Altogether, a first pool of content items that corresponds to a target audience with a first defining characteristic can include different content items in comparison to a target audience with a different defining characteristic. In various embodiments, the content items in the first pool of content items are provided to the content presentation module 180 to be transmitted to client devices 110.

In some embodiments, the online system 130 selects one or more content items that are highly performing based on a particular criteria, for example, contents items that receive more than a threshold number of user interactions of particular types in a given time interval. The online system 130 generates additional content items based on content components selected from the one or more selected content items. For example, the online system 130 may propagate a content component that is included in a first content item into a new content item. Additionally, the online system 130 may propagate a different content component included in a second content item into the same new content item. Alternatively, the online system 130 may replace a content component of a selected content item with another content component of the same component type. The other content component may be selected arbitrarily. Details of these embodiments are further described herein.

### Applying Rules in Selecting Content Components

In some embodiments, the content component assembly module 205 additionally works together with the content component rule module 215 in generating a content item. Generally, applicable rules or constraints associated with various content components can limit the content components that can be included in a particular content item. The application of rules for generating a content item is described in further detail in U.S. application Ser. No. 15/397,537, which is hereby incorporated by reference in its entirety.

In some embodiments, the rules are provided by the content provider system 140, where the rules describe how the content components should be assembled into a content item. The content component rule module 215 receives the rules associated with the content item from the content provider system 140 and stores the received rules in the content component rule store 220. When a content item is to be assembled, the content component rule module 215 selects applicable rules for assembling the content components of the content item and applies the selected rules to the selected content components that are to be used to assemble the content item.

In one embodiment, each rule for creating a content item includes a condition, an operator and a type of action to be performed on one or more content components. A Condition defines when an action and what type of an action should be applied to one or more content components to be included in the content item. Examples of conditions include: Boolean, string, int (representing an integer value); examples of operator include: not equal, equal, bigger than, smaller than, logic “AND” and logic “OR.” As an example, a condition may be a defining characteristic of the target audience. Example actions that can be applied to content components include: group (e.g., two content components must both be included in the same content item), mutex (e.g., two content components are not to be included in the same content item), promote (e.g., a content component must be included in a content item), demote (e.g., a content component is not to be included in a content item), and template (e.g., replacing a text string with another text string).

As an example process of applying a rule, the content component rule module 215 receives the one or more defining characteristics of the target audience such as age, gender, ethnicity, and other information of an individual in the target audience. A rule may specify a defining characteristic e.g., that a content component is only to be selected for individuals in a target audience between 18-25 years old. Content components that do not satisfy the rules are removed from consideration for the target audience. The remaining content components are further analyzed for inclusion in the content item by the content component assembly module 205.

### Iterative Modification of the Pool of Content Items

FIG. 2B is a block diagram of a genetic modification module 250, in accordance with one embodiment. The genetic modification module 250 can include an action analysis module 255, a content component crossover module 260, a content component mutation module 265, and a content item evaluation module 270.

The action analysis module 255 receives actions performed by users of the online system 130 and populates an action log to track the received actions. A user action refers to any interaction associated with a user of the online system 130. In various embodiments, the interaction associated with the user occurs on the online system 130. For example, this includes the user liking content (e.g. photos, status updates, check-ins, emoticons, stickers), posting or sharing content, or commenting on content. In various embodiments, the interaction occurs between the user of the online system 130 and a content item provided and/or generated by the online system 130. Specifically, additional interactions between a user and a content item can include a click or a conversion (e.g., purchase of an item in the content item).

In various embodiments, the interaction associated with the user occurs external to the online system 130. As an example, the interaction can include a user purchase of a virtual or tangible product from a third party system (e.g., a retailer). The online system 130 may work with the third party system in order to obtain the interactions associated with a user that occur external to the online system 130.

The action analysis module 255 uses information stored in the action log to infer interests of the user of the online system 130. For example, as described above, each interaction performed by the user of the online system 130 can be used to generate an edge between a node representing the user of the online system 130 and a second node. In various embodiments, if the user interacted with a content item, then the second node represents the content item or a topic associated and/or extracted from the content item. An increasing number of edges between a node representing the user of the online system 130 and a second node can indicate an inferred interest of the user of the online system 130. Such inferred interests (and explicit interests such as those provided by the user of the online system 130) are used to place users in target audiences such that they can be provided the appropriate content item.

In various embodiments, the action analysis module 255 uses information stored in the action log to generate metrics for each of the content items. For example, metrics of each content item can include a click-through rate, an impression rate, total number of conversions, conversion rate, cost per conversion, total cost, and the like. Metrics represent the performance of each content item that was presented to a target audience. In various embodiments, each content item is provided to client devices 110 for a pre-determined amount of time (e.g., several hours, a day, a week) as a trial period and therefore, the action analysis module 255 generates metrics for the performance of the content during the trial period. In some embodiments, a content item can be provided for presentation multiple times (e.g., across multiple trial periods). Therefore, the action analysis module 255 can determine metrics for each trial period that the content item was provided for.

The content component crossover module 260 modifies each pool of content items that is specific for a target audience based on the metrics generated for each content item in the pool. In various embodiments, the content component crossover module 260 iteratively performs this process in modifying a pool of content items. At each iteration, the content component crossover module 260 retrieves the pool of content items as well as the metrics generated by the action analysis module 255 for each content item in the pool. Based on the metrics, the content component crossover module 260 eliminates a subset of content items in the pool that demonstrate the poorest performance and generate additional content items to be included in the pool. In various embodiments, the content component crossover module 260 generates the additional content items by crossing over one or more content components that are included in a pair of content items that remain in the pool. As used hereafter, crossing over a content component refers to a generation of a new content item that includes content components pulled from two or more other content items. Altogether, this removes poorly performing content items from the pool of content items while increasing the number of highly performing content items in the pool. As the content component crossover module 260 performs this process over various iterations, the pool of content items is narrowed to include the highest performing content items and can identify the one or more content items that are likely to be of interest to users of a target audience.

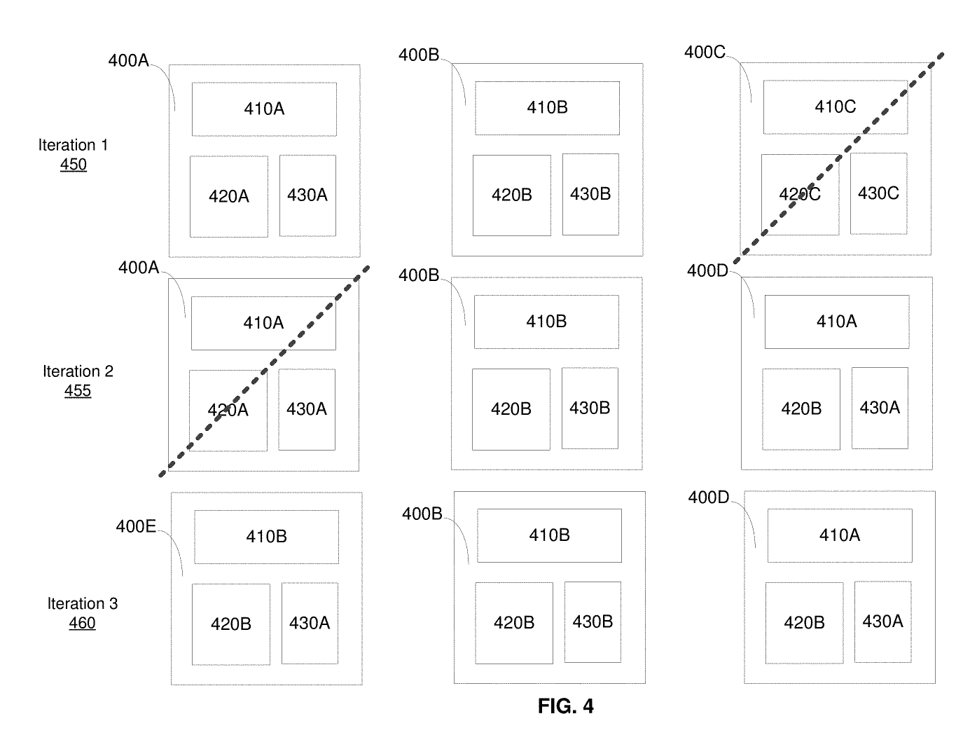

Reference is now made to FIG. 4, which is a depiction of the iterative process of modifying a pool of content items, in accordance with one embodiment. At a first iteration 450, the content component crossover module 260 receives an initial pool of content items generated by the content component assembly module 205 and provided for presentation to client devices 110 by the content presentation module 180. For example, as shown in FIG. 4, the initial pool of content items can include a first content item 400A, a second content item 400B, and a third content item 400C. Each content item 400 is assembled from individual content components (e.g., 410A-C, 420A-C, and 430A-C). One skilled in the art can understand that a pool of content items can include hundreds, thousands or more content items. Additionally, each content item 400 can include more than the three individual content components as shown in FIG. 4, which is used for example purposes only.

The content component crossover module 260 retrieves the metrics of each content item 400 in the pool. In various embodiments, the content component crossover module 260 ranks the content items 400 in the pool according to the retrieved metrics. For example, the content component crossover module 260 may rank each of content item 400A-C based on the click through rate of each content item 400A-C. The content component crossover module 260 removes content items from the pool according to their associated metrics. For example, as shown in FIG. 4, the content component crossover module 260 determines that the worst performing content item in the pool is content item 400C. Therefore, content item 400C is discarded from the pool, as indicated by the dotted diagonal line. In various embodiments, the content component crossover module 260 sets a threshold metric value and eliminates content items from the pool based on the threshold metric value. As an example, each content item that falls below the threshold metric value is removed from the pool. In various embodiments, the content component crossover module 260 removes a fixed number of a fixed percentage of content items from the pool.

The content component crossover module 260 generates one or more additional content items to replenish the pool of content items for a subsequent iteration. As shown in FIG. 4, the content component crossover module 260 generates an additional content item 400D to replace content item 400C at a subsequent iteration (e.g., iteration 2 (455)). Additional content item 400D is assembled from content components that were also included in content items that were not removed from the pool, such as content items 400A and 400B. More specifically, content item 400D includes a first content component 410A and third content component 430A, both of which were included in content item 400A. Additionally, content item 400D includes a second content component 420B that was included in content item 400B. Here, content item 400A and content item 400B serve as the parent content items for new content item 400D. The content component crossover module 260 can check to ensure that the additional content item 400D does not replicate a content item that is already in the pool.

In various embodiments, the content component crossover module 260 may perform a process in determining the content components that will be included in the additional content item. The content component crossover module 260 curates the content components that are included in content items that remain in the pool. For example, referring to FIG. 4, the content component crossover module 260 curates content component 410A and 410B for a first content component type of, content component 420A and 420B for a second content component type, and content component 430A and 430B for a third content component type. In one embodiment, the content component crossover module 260 randomly selects content components from the set of curated content components to be included in the additional content item 400D.

In other embodiments, the content component crossover module 260 selects content components for an additional content item based on generated metrics for each content component. For example, the content component crossover module 260 can generate a cumulative metric for a content component by averaging the metric of each content item 400 that included the content component. In various embodiments, the content component of each type that is associated with the highest metric is selected to be included in the additional content item 400D. Additional content item 400D is included in the modified pool of content items. The content component crossover module 260 provides the modified pool of content items to the content presentation module 180 such that each of the content items in the modified pool can be provided for presentation.

At a second iteration 455, the content component crossover module 260 may repeat the process of modifying the pool of content items. The content component crossover module 260 retrieves metrics of each content item while each of the content items were provided for presentation. In some embodiments, if content item was maintained from a previous pool of content items, the content component crossover module 260 may combine the metrics for a content item in this second iteration with the metrics for the content item in a previous iteration. For example, the content component crossover module 260 may average the metrics across the one or more iterations for a content item. In some embodiments, the content component crossover module 260 assigns weights to the different metrics for a content item based on the iteration that the metrics was generated for. For example, if at a second iteration 455, the content component crossover module 260 assigns a higher weight to a metric for a content item corresponding to the second iteration 455 and assigns a lower weight to a metric for the same content item corresponding to the first iteration 450. This reflects the likelihood that the metrics corresponding to the most recent iteration (e.g., second iteration 455) is more representative of the performance of the content item as opposed to an earlier iteration. In some embodiments, the content component crossover module 260 ignores the metric generated for the content item corresponding to an earlier iteration (e.g., first iteration 450) and only uses the metric generated for the content item corresponding to the current iteration (e.g., second iteration 455).

As described above, the content component crossover module 260 identifies and removes content items from the pool based on their associated metrics. As shown in FIG. 4, as iteration 2 (455), the content component crossover module 260 determines that content item 400A is to be removed based on its associated metric. As described above, the content item 400A may be below a threshold value (e.g., a threshold rank, or a threshold metric value) and is therefore selected to be removed. The content component crossover module 260 maintains content items 400B and 400D in the pool of content items.

The content component crossover module 260 generates additional content items for a subsequent iteration (e.g., iteration 3 (460)) that includes the content components from the content items that remain in the pool. As shown in FIG. 4, the content components of the additional content item 400E includes a first content component 410B and second content component 420B, which are both derived from content item 400B, and a third content component 430A, which is derived from content item 400D. Thus, additional content item 400E is included into the modified pool of content items. In various embodiments, the content component crossover module 260 can continue to iteratively modify the pool of content items by removing and regenerating content items in the pool.

The content component crossover module 260 identifies the appropriate number of iterations to terminate the iterative process and provides the final pool of content items to the content item evaluation module 270. In various embodiments, the content component crossover module 260 terminates the iterative process after a threshold number of iterations. In some embodiments, the content component crossover module 260 terminates the iterative process when the pool of content items includes a minimum number of different content components of each content component type. This ensures that the pool of content items includes the highest performing content components, but also remains sufficiently diverse. In some embodiments, the content component crossover module 260 terminates the iterative process when a difference between content items in a pool of content items is below a threshold when compared to content items in a pool of content items of a prior iteration. In some embodiments, the content component crossover module 260 terminates the iterative process when an improvement in the aggregate rate of user interactions with the content items of the pool in successive iterations is below a threshold value.

The content component mutation module 265 increases the diversity of content components in the pool of content items. Specifically, the content component mutation module 265 can inject an additional content component into the pool of content items by including the additional content component in a content item in the pool. Therefore, the content component mutation module 265 ensures that the pool of content items does not become too limited. Thus, if an additional content component were to perform well in a content item, then the additional content component can be propagated by crossing over into additional content items in the pool at subsequent iterations.

In various embodiments, the content component mutation module 265 injects an additional content component into the pool of content items by replacing an existing content component in a content item in the pool with an additional content component. In some embodiments, the content component mutation module 265 generates a new content item to be included in the pool of content items that includes an additional content component. In various embodiments, the content component mutation module 265 inserts the additional content component or content item including the additional content component after newly receiving the additional content component. For example, the additional content component may be newly provided by the content provider system 140 and can further specify characteristics of a target audience for the additional content component. Therefore, the content component mutation module 265 identifies the pool of content items corresponding to the target audience and includes the additional content component (e.g., by replacing an existing content component or including within a new content item). In some embodiments, the content component mutation module 265 inserts the additional content component or content item including the additional content component after a threshold number of iterations have occurred.

The content item evaluation module 270 receives a final pool of content items and evaluates the individual content items for presentation to a target user. The content item evaluation module 270 may evaluate the content items in response to a request (e.g., an advertisement request) that identifies a target user and/or characteristics of a target user. Each content item can be evaluated based on a variety of evaluation factors (e.g., age of each content item, whether the content item has previously been shown, whether the content item has the highest bidding value) and selects the best content item for the target user at that particular moment.

The content item selected and presented to the target user can be included as a part of an advertisement campaign. In various embodiments, the content item evaluation module 270 may further evaluate additional content items such as content items from other final pools of content items that correspond to other target audiences. Therefore, in these embodiments, the content item evaluation module 270 evaluates the best content items throughout all final pools of content items in selecting a content item for presentation to the target user. In some embodiments, the content item evaluation module 270 may further evaluate content items such as those that are fully assembled by a content provider system 140 in addition to the content items that are dynamically generated by the online system.

### Providing a Tailored Content Item to a Target User

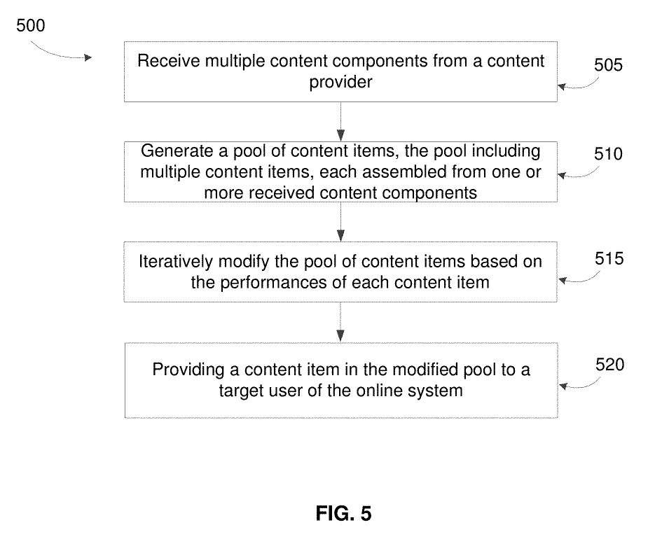

FIG. 5 is a flow diagram 500 for providing an optimized content item to a user of the online system, in accordance with one embodiment. The online system 130 receives 505 multiple content components to be assembled into a content item from a content provider system 140. The online system 130 generates 510 a pool of content items that is specific for a target audience. Each content item is assembled from one or more of the received content components. In various embodiments, the content items are assembled such that individuals of the target audience may be interested in the content items. For example, the online system 130 can apply trained models in determining content components that would likely be of high interest to individuals of the target audience. Therefore, the content items in the pool can include those content components.

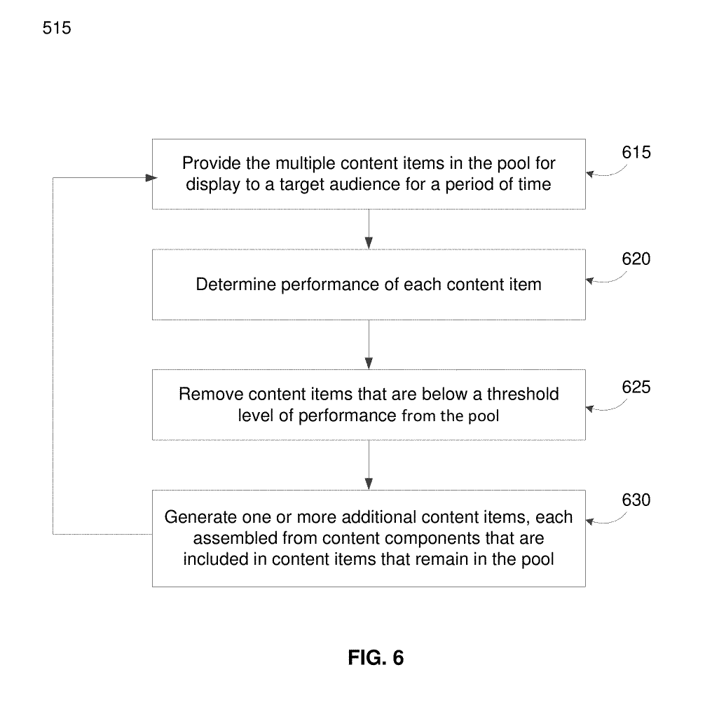

The online system 130 iteratively modifies 515 the pool of content items based on the performances of each content item. More specifically, FIG. 6 is a detailed flow process of step 515 for iteratively modifying the pool of content items, in accordance with an embodiment. The online system provides 615 the content items in the pool to a target audience for viewing for a period of time. In various embodiments, the period of time is relatively short (e.g., several hours, a day, or several days) in comparison to standard advertisement campaigns (e.g., weeks or months). The online system 130 determines 620 the performance of each content item amongst the target audience. For example, the performance of the content item can be a metric such as a click-through rate, conversion rate, cost per click, and the like. The online system 130 removes 625 content items from the pool that are below a threshold level of performance. The online system 130 generates one or more additional content items to be included in the pool that are assembled using content components that were included in content items that remain in the pool. Therefore, removing poorly performing content items and including additional content items modifies the pool of content items.

The online system 130 can repeat steps 615, 620, 625, and 630 through an iterative process. Therefore, the pool of content items can be continually modified to eliminate content items (and the content components in the eliminated content items) while propagating the content components that are associated with favorable metrics. Returning to FIG. 5, after iteratively modifying the pool of content items, the online system 130 provides 520 a content item selected from the modified pool of content items to a target user of the online system 130.

### Alternative Embodiments

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method comprising:
receiving, by an online system, a plurality of content components of a content item from a content provider, each content component having a component type;
generating a pool of content items for a target audience, the pool of content items comprising a plurality of content items, each content item assembled from content components selected from the plurality of received content components;
iteratively modifying the pool of content items, the modifying comprising:
monitoring performance of each content item in the pool,
removing content items with a determined performance that is below a threshold level from the pool of content items, and
generating an additional content item for inclusion in the pool of content items, wherein the additional content item is assembled from one or more content components that are also included in content items that remain in the pool of content items;
distributing a content item selected from the pool of content items to target users of the online system.

2. The method of claim 1, wherein monitoring performance of each content item in the pool comprises:
providing the plurality of content items in the pool for display to the target audience for a time period;
determining a performance of each of the plurality of content items.

3. The method of claim 1, wherein generating the additional content item comprises:
curating content components included in content items that remain in the pool of content items;
generating a cumulative metric for each curated content component;
selecting a subset of curated content components based on the cumulative metrics; and
assembling the additional content item using the selected subset of curated content components.

4. The method of claim 1, wherein generating the additional content item comprises selecting a pair of parent content items from the pool and creating a new content item by taking content components from each parent content item of the pair.

5. The method of claim 1, wherein generating the additional content item comprises:
selecting a content item from the pool of content items;
selecting a content component from the selected content item, wherein the content components is of a particular component type; and
replacing the selected component with a different content component of the particular component type.

6. The method of claim 1, wherein the performance of each content item is determined using a performance metric comprising one or more of a click-through rate, an impression rate, total number of conversions, conversion rate, cost per conversion, or a total cost.

7. The method of claim 1, wherein at each iteration, the performance of each of the plurality of content items is monitored by:
for each of the plurality of content items:
determining a metric for the content item corresponding to a time period that the plurality of content items are provided for display; and
combining the determined metric with one or more determined metrics for the content item that correspond to time periods of previous iterations.

8. The method of claim 1, wherein each content component has a content component type that is one of an image, video, title, body, call for action type, universal resource link (URL), description and caption.

9. The method of claim 1, wherein each content item in the plurality of content items in the pool of content items is generated by randomly selecting content components from the plurality of received content components.

10. The method of claim 1, wherein generating the pool of content items for the target audience comprises:
providing each content component in the received plurality of content components as input to a trained machine learning based model;
selecting a subset of content components based on a predicted score for each content component outputted by the trained machine learning based model; and
assembling a content item from the selected subset of content components.

11. A non-transitory computer readable medium comprising computer code that, when executed by a processor, causes the processor to:
receive, by an online system, a plurality of content components of a content item from a content provider, each content component having a component type;
receive, by an online system, a plurality of content components of a content item from a content provider, each content component having a component type;
generate a pool of content items for a target audience, the pool of content items comprising a plurality of content items, each content item assembled from content components selected from the plurality of received content components;
iteratively modify the pool of content items, wherein the code that causes the processor to iteratively modify the pool of content items further comprises code that, when executed by the processor, causes the processor to:
monitor performance of each content item in the pool,
remove content items with a determined performance that is below a threshold level from the pool of content items, and
generate an additional content item for inclusion in the pool of content items, wherein the additional content item is assembled from one or more content components that are also included in content items that remain in the pool of content items;
distribute a content item selected from the pool of content items to target users of the online system.

12. The non-transitory computer readable medium of claim 11, wherein the computer code that causes the processor to monitor performance of each content item in the pool further comprises computer code that, when executed by the processor, causes the processor to:
provide the plurality of content items in the pool for display to the target audience for a time period;
determine a performance of each of the plurality of content items.

13. The non-transitory computer readable medium of claim 11, wherein the computer code that causes the processor to generate the additional content item further comprises computer code that, when executed by the processor, causes the processor to:
curate content components included in content items that remain in the pool of content items;
generate a cumulative metric for each curated content component;
select a subset of curated content components based on the cumulative metrics; and
assemble the additional content item using the selected subset of curated content components.

14. The non-transitory computer readable medium of claim 11, wherein the computer code that causes the processor to generate the additional content item further comprises code that, when executed by the processor, causes the processor to select a pair of parent content items from the pool and create a new content item by taking content components from each parent content item of the pair.

15. The non-transitory computer readable medium of claim 11, wherein the computer code that causes the processor to generate the additional content item further comprises computer code that, when executed by the processor, causes the processor to:
select a content item from the pool of content items;
select a content component from the selected content item, wherein the content components is of a particular component type; and
replace the selected component with a different content component of the particular component type.

16. The non-transitory computer readable medium of claim 11, wherein the performance of each content item is determined using a performance metric comprising one or more of a click-through rate, an impression rate, total number of conversions, conversion rate, cost per conversion, or a total cost.

17. The non-transitory computer readable medium of claim 11, wherein at each iteration, the computer code that causes the processor to monitor performance of each of the plurality of content items further comprises computer that, when executed by the processor, causes the processor to:
for each of the plurality of content items:
determine a metric for the content item corresponding to a time period that the plurality of content items are provided for display; and
combine the determined metric with one or more determined metrics for the content item that correspond to time periods of previous iterations.

18. The non-transitory computer readable medium of claim 11, wherein each content component has a content component type that is one of an image, video, title, body, call for action type, universal resource link (URL), description and caption.

19. The non-transitory computer readable medium of claim 11, wherein each content item in the plurality of content items in the pool of content items is generated by randomly selecting content components from the plurality of received content components.

20. The non-transitory computer readable medium of claim 11, wherein the computer code that causes the processor to generate the pool of content items for the target audience further comprises computer that, when executed by the processor, causes the processor to:
provide each content component in the received plurality of content components as input to a trained machine learning based model;
select a subset of content components based on a predicted score for each content component outputted by the trained machine learning based model; and
assemble a content item from the selected subset of content components.
